(19) United States
(12) Patent Application Publication
(10) Pub. No.: US 2026/0245294 A1
(43) Pub. Date: Aug. 20, 2026

(54) Positional Encoding for Neural Network Attention

(71) Applicant: Google LLC, Mountain View, CA (US)

(72) Inventors: Seyed Mohammad Mehdi Sajjadi, Berlin (DE); Aleksandr Safin, Berlin (DE); Daniel Christopher Duckworth, Berlin (DE)

(21) Appl. No.: 19/471,171

(22) PCT Filed: Apr. 1, 2024
(86) PCT No.: PCT/US2024/022548

§ 371 Date: Sep. 30, 2025

Related U.S. Application Data
(60) Provisional application No. 63/493,349, filed on Mar. 31, 2023.

(51) Int. Cl. G06T 15/20; B25J 9/16; G06T 7/73

(52) U.S. Cl. CPC G06T 15/20; B25J 9/1697; G06T 7/75

(57) ABSTRACT

An example computer-implemented method for image view synthesis is provided. The example method includes obtaining, by a computing system, a query associated with a target view of a scene; determining, by the computing system, a plurality of source poses associated with a plurality of source images of the scene; generating, by the computing system and based on the query, a plurality of pose-augmented queries, each respective pose-augmented query encoding pose information relative to a respective source pose associated with a respective source image of the plurality of source images; processing, by the computing system, the plurality of pose-augmented queries respectively with a plurality of attention streams of a machine-learned image view synthesis model; and generating, by the computing system and based on the plurality of attention streams, an output image of the scene associated with the target view.

### PRIORITY

This application claims priority to and the benefit of U.S. Provisional Application No. 63/493,349 (filed Mar. 31, 2023). U.S. Provisional Application No. 63/493,349 is hereby incorporated by reference herein in its entirety.

### FIELD

The present disclosure relates generally to machine learning. More particularly, the present disclosure relates to encoding positional information for processing by neural network attention mechanisms.

### BACKGROUND

A computer can receive input(s). The computer can execute instructions to process the input(s) to generate output(s) using a parameterized model. The computer can obtain feedback on its performance in generating the outputs with the model. The computer can generate feedback by evaluating its performance. The computer can receive feedback from an external source. The computer can update parameters of the model based on the feedback to improve its performance. In this manner, the computer can iteratively “learn” to generate the desired outputs. The resulting model is often referred to as a machine-learned model. Novel view synthesis techniques generally involve using a system for generating an image depicting a particular viewpoint of a scene when the system has not been exposed to the scene from the particular viewpoint (i.e., the view is “novel”).

### SUMMARY

Aspects and advantages of embodiments of the present disclosure will be set forth in part in the following description, or can be learned from the description, or can be learned through practice of the embodiments.

In one example aspect, the present disclosure provides an example computer-implemented method for image view synthesis. The example method can include obtaining, by a computing system, a plurality of source images of a scene. The example method can include obtaining, by the computing system, a query associated with a target view of the scene. The example method can include generating, by the computing system and based on the query, a plurality of pose-augmented queries, each respective pose-augmented query encoding pose information relative to a respective source pose associated with a respective source image of the one or more source images. The example method can include processing, by the computing system, the plurality of pose-augmented queries with a respective plurality of attention streams of a machine-learned image view synthesis model. The example method can include generating, by the computing system and based on the plurality of attention streams, an output image of the scene associated with the target view.

In another example aspect, the present disclosure provides an example computer-readable non-transitory medium storing instructions executable by one or more processors to cause the computing system to perform the example method.

In another example aspect, the present disclosure provides an example computing system that includes the example computer-readable non-transitory medium and the one or more processors.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to describe the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 is a block diagram of an example system for image view synthesis according to example aspects of some embodiments of the present disclosure;

FIG. 2 is a block diagram of an example relative pose attention block according to example aspects of some embodiments of the present disclosure;

FIG. 3 is a block diagram of an example configuration of an image view synthesis model according to example aspects of some embodiments of the present disclosure;

FIG. 4 is a block diagram of an example configuration of an image view synthesis model encoder according to example aspects of some embodiments of the present disclosure;

FIG. 5 is a block diagram of an example configuration of an image view synthesis model decoder according to example aspects of some embodiments of the present disclosure;

FIG. 6 is a block diagram of an example system for training an image view synthesis model according to example aspects of some embodiments of the present disclosure;

FIG. 7 is a flow chart diagram of an example method for image view synthesis according to example aspects of some embodiments of the present disclosure.

FIG. 8 is a flow chart diagram illustrating an example method for training a machine-learned model according to example implementations of aspects of the present disclosure;

FIG. 9 is a block diagram of an example processing flow for using machine-learned model(s) to process input(s) to generate output(s) according to example implementations of aspects of the present disclosure;

FIG. 10 is a block diagram of an example sequence processing model according to example implementations of aspects of the present disclosure;

FIG. 11 is a block diagram of an example technique for populating an example input sequence for processing by a sequence processing model according to example implementations of aspects of the present disclosure;

FIG. 12 is a block diagram of an example model development platform according to example implementations of aspects of the present disclosure;

FIG. 13 is a block diagram of an example training workflow for training a machine-learned model according to example implementations of aspects of the present disclosure;

FIG. 14 is a block diagram of an inference system for operating one or more machine-learned model(s) to perform inference according to example implementations of aspects of the present disclosure;

FIG. 15 is a block diagram of an example networked computing system according to example implementations of aspects of the present disclosure;

FIG. 16 is a block diagram of an example computing device according to example implementations of aspects of the present disclosure; and

FIG. 17 is a block diagram of an example computing device according to example implementations of aspects of the present disclosure.

Reference numerals that are repeated across plural figures are intended to identify the same features in various implementations.

### DETAILED DESCRIPTION

### Overview

Example aspects of the present disclosure generally relate to novel view synthesis. Novel view synthesis can include the rendering of an image of a new view of a scene based on other images from other views of the scene. Example aspects of the present disclosure provide a machine-learned image view synthesis model that can generate an image of a target view of a scene based on one or more source images of the scene. The target view can be specified at inference time with a query. For instance, a query can include a ray and the machine-learned image view synthesis model can return, in response to the query, a value/color of the scene at the point intersected by the ray.

The pose of the query ray can be defined with respect to various reference frames. For instance, the query ray can be parameterized in a spatial frame associated with the source images. The query ray can be parameterized based on relative pose with respect to the source images (e.g., a “camera” pose for each source image). In this manner, for instance, the machine-learned image view synthesis model can be invariant to absolute pose.

In an example implementation using transformer architectures, the self-attention mechanism of a transformer block can use relative pairwise camera pose information. For instance, the self-attention mechanism of a transformer block can obtain query, key, and value matrices by transforming an input sequence using learned query, key, and value weights. In an example machine-learned image view synthesis model, one or more of the query, key, and value matrices can be augmented with pose data such that interactions (e.g., self-attention) across the query and keys/values can directly account for relative positioning of the query and keys/values. For instance, for the query and keys, ray coordinates can be used in a coordinate of a camera associated with the key.

Pose invariance can offer several advantages. For instance, in some cases, a machine-learned image view synthesis model can be used to synthesize views of large scenes. When synthesizing novel views of a scene at rays far from the pose of a given source image, it may be desired to change the source images used by the machine-learned image view synthesis model to source images closer to the queried target. Advantageously, an absolute pose-invariant model can provide for seamless transition as the source images are replaced or updated. In contrast, in some situations pose-variant models can demonstrate unstable image renderings, even of the same viewpoint. This may appear as flickering or a wavy instability in the output image, as if the image was being diffracted through water or other distortion.

Of further advantage, by leveraging relative pose information to spatially register visual information, example machine-learned image view synthesis models according to the present disclosure can leverage a pose-invariant architecture in lieu of requiring that the model implicitly learn pose invariance. For instance, by augmenting the self-attention pathways of an example transformer model such that self-attention interactions occur in a relative coordinate space, the architecture of the model can induce pose invariance and the learning capacity of the model can be preserved for learning to synthesize the scene with higher acuity.

Example aspects of the present disclosure can provide a number of technical effects and benefits. Example implementations can provide for increased stability of model output by reducing variance due to absolute pose shifts. For instance, as large scenes are traversed and source images are replaced or rearranged, pose invariant models can offer increased robustness to absolute pose shifts and provide more seamless output synthesized imagery. This seamless output can improve end user experiences (e.g., perceptual quality), measured performance over time (e.g., mean accuracy), decrease streaming bandwidth demands (e.g., due to more predictable/smooth behavior being easier to compress, etc.), and the like.

Although described herein in various examples with respect to example implementations for novel view synthesis, it is to be understood that the techniques described herein may be used for other tasks in various technological fields. In general, the present techniques can provide for embedding relational information within an attention mechanism of a machine-learned model. Such relational information may be positional/spatial information, temporal information, chemical reactivity information, or other relational information. By encoding such relational information within the architecture of the model itself, the expressivity of the model may be enhanced for a given model size, since the model parameters may be freed from learning to encode the relational information. Further, by encoding such relational information explicitly, the model can provide improved visibility into its operation and can reduce model hallucinations with respect to the encoded relational information. This in turn can improve the reliability and robustness of the model.

The following paper is hereby incorporated by reference herein in its entirety: Mehdi S. M. Sajjadi, Henning Meyer, Etienne Pot, Urs Bergmann, Klaus Greff, Noha Radwan, Suhani Vora, Mario Lucic, Daniel Duckworth, Alexey Dosovitskiy, Jakob Uszkoreit, Thomas Funkhouser, Andrea Tagliasacchi, Scene Representation Transformer: Geometry-Free Novel View Synthesis Through Set-Latent Scene Representations, arXiv:2111.13152v3 (Tue, 29 Mar. 2022 10:37:07 UTC), https://doi.org/10.48550/arXiv.2111.13152.

The following paper is hereby incorporated by reference herein in its entirety: Mehdi S. M. Sajjadi, Daniel Duckworth, Aravindh Mahendran, Sjoerd van Steenkiste, Filip Pavetić, Mario Lučić, Leonidas J. Guibas, Klaus Greff, Thomas Kipf, Object Scene Representation Transformer, arXiv:2206.06922v2 (Wed, 12 Oct. 2022 09:45:45 UTC), https://doi.org/10.48550/arXiv.2206.06922.

The following paper is hereby incorporated by reference herein in its entirety: Mehdi S. M. Sajjadi, Aravindh Mahendran, Thomas Kipf, Etienne Pot, Daniel Duckworth, Mario Lucic, Klaus Greff, RUST: Latent Neural Scene Representations from Unposed Imagery, arXiv:2211.14306v2 (Fri, 24 Mar. 2023 16:56:25 UTC), https://doi.org/10.48550/arXiv.2211.14306.

Example aspects of the present disclosure are discussed in the enclosed Appendix and herein in reference to the enclosed figures.

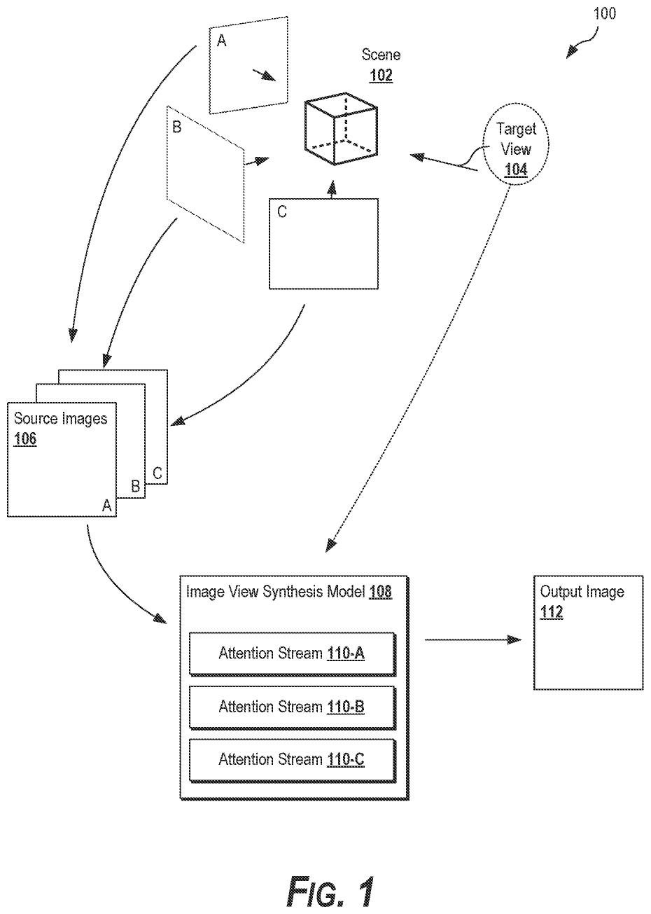

FIG. 1 is a block diagram of an example image view synthesis framework 100 according to example aspects of some embodiments of the present disclosure. Given a scene 102, the user may desire a novel target view 104. For instance, source images 106 can include images that depict scene 102 from different views other than the target view 104. Image view synthesis model 108 can process the source images 106 using and the target view 104 to generate an output image 112 that is associated with the target view 104.

The image view synthesis model 108 can leverage an attention mechanism for determining what data is relevant for returning an output image 112 associated with the query target view 104. The attention mechanism can include multiple attention streams 110-A, 110-B, 110-C. These attention streams can correspond to different source poses of source images 106. For instance, on the input side, each attention stream can be configured for learning about the stream from the viewpoint of a respective source image. On the output side, each attention stream can be configured for determining what information from its learned perspective is pertinent to servicing the query. For instance, in this manner, each attention stream can operate in a coordinate space relative to its corresponding source pose. When processing a query requesting a particular target view or pose, the query can be augmented with its pose relative to the coordinate space of each attention stream for processing by each stream.

Image view synthesis framework 100 can be implemented on one or more computing devices or systems. Image view synthesis framework 100 can be implemented in a variety of different contexts. In general, image view synthesis framework 100 can be implemented in any suitable image processing pipeline on distributed or local computing systems.

In an example, image view synthesis framework 100 can be employed in the creation of virtual reality (VR) and augmented reality (AR) experiences. Generating realistic views of a scene from various angles can help provide a realistic and immersive experience for users. Framework 100 can be used to generate these views from an inexpensive set of source images, potentially reducing the amount of data or other resources used to create a realistic VR or AR environment, thereby improving the efficiency of such systems. Additionally, the framework's ability to generate views without reliance on explicit, clean pose data can allow for more flexibility in creating AR and VR experiences with limited reference data as well as improving an experience using lower-cost (e.g., noisier) pose-tracking sensors. This can allow for capture and generation of AR or VR imagery using lower-cost, lower-power devices and systems.

In an example, image view synthesis framework 100 can be used for static animation content (e.g., audiovisual recordings) or interactive animated content (e.g., video games). Framework 100 can allow users to create a multitude of perspectives of a scene with a reduced amount of manual input and less reliance on expensive pose data. This can allow the creation of a more immersive and dynamic content by rendering different perspectives of a scene (e.g., interactively based on a player's actions).

In an example, image view synthesis framework 100 can also be used for robotic perception and motion control. For instance, framework 100 can generate views of a scene from various perspectives based on images captured by cameras or other sensors of the robot or in the robot's environment. This can provide a comprehensive representation of the surroundings that can be used to reason over perspectives of a scene that might not be directly represented in an initial source image set. This can enable the robot to navigate its environment more effectively and to perform tasks such as object manipulation with greater accuracy. The ability of the framework to generate views without explicit pose data can also be beneficial in robotic applications, as it can allow the robot to generate accurate views of its environment even when its sensors fail to provide precise pose information. The ability of the framework to operate invariant to choose of coordinate system can allow for lower noise operation (e.g., improved stability in image signal) which in turn can provide for higher confidence perception of the environment and interaction with the environment.

Additionally, or alternatively, a latent representation with learned pose signals can be used by a robotic system as an input layer interfacing between a decision-making system and a perception system. For example, a learned latent scene representation can be used as an input to another machine-learned model that is configured to reason over the scene and generate one or more actions for responding to the environment or scene.

Scene 102 can be any object, environment, or setting represented by source images 106. Scene 102 can be a real-world scene or an artificial scene. Scene 102 can be a human-interpretable scene (e.g., a scene of objects recognizable or otherwise interpretable by humans). Scene 102 can include any data that can be projected into multiple projections (e.g., with the novel view task being to generate a new projection of the data).

An example scene includes a real-world environment as perceived by a robot. The scene can include a controlled environment (e.g., a factory) or an uncontrolled environment (e.g., a busy sidewalk or street). An example scene includes a real-world environment as perceived by a user device. For instance, an example scene includes a real-world environment that a user is interacting with. It could be the living room where a user is playing an augmented reality game, or it could be a city street where a user is using an augmented reality navigation app. In these scenarios, example implementations of the present disclosure can generate novel views of scene 102 in real-time, providing the user with a seamless and immersive augmented reality experience. The generated novel views can help the user explore the augmented reality environment from different perspectives, enhancing the feeling of immersion and improving the overall user experience.

An example scene includes a medical subject imaged by a medical imaging device. The present disclosure can be used to synthesize novel views of the subject that are not directly present in the original images. This can provide enhanced visualization of the anatomy or pathology of interest, potentially assisting radiologists or other medical professionals in diagnosis and treatment planning. The ability to generate novel views without explicit pose data can be particularly advantageous in medical imaging, where the pose of the scanned subject can vary widely and may not be precisely known (e.g., such as in telehealth applications where an initial capture could be recorded in an uncontrolled environment at a patient's location). Further, the capacity to operate invariant to choice of coordinate system can allow for lower noise operation (e.g., improved stability in image signal) which in turn can provide for higher confidence results of analysis using the framework.

Source images 106 can include one or more images recorded or captured from different views of scene 102. These images can be collected from any device or system with an imaging or other perception sensor. They may also be generated by computer graphics software or obtained from existing databases or collections of images. Source images 106 can include one or multiple value channels (e.g., grayscale, RGB, alpha, etc.).

Source images 106 can be of various resolutions. Source images 106 can all be of the same resolution. Source images 106 can include a set of images having varied resolutions.

Each of the source images 106 can contain data describing a different perspective or viewpoint of scene 102. For instance, the images can correspond to viewpoints having different distances and orientations with respect to a reference or origin of scene 102. This variety in views can provide the image view synthesis model with a comprehensive understanding of the scene, enabling it to generate accurate and realistic novel views. Source images 106 can include both foreground and background elements of the scene. Source images 106 can capture various lighting conditions, colors, textures, and shapes.

Source images 106 can be preprocessed before being provided to image view synthesis model 108. Preprocessing can involve operations such as image resizing, normalization, augmentation, or other transformations. Preprocessing can help to standardize the input data, enhance certain features of the images, or increase the robustness and generalizability of the image view synthesis model.

For example, source images 106 can include variations of image attributes that are unrelated to scene 102. For example, source images 106 can include multiple images of the same or similar views that are varied in coloration (e.g., white balance), brightness (e.g., exposure), noise, etc. In this manner, for instance, image view synthesis model 108 can learn to encode the geometry of scene 102 with invariance to the attributes of the image(s) themselves. Additionally, or alternatively, latent pose data can include a learned dimension that corresponds to one or more image attributes (e.g., white balance, exposure, etc.), such that novel views can be generated that possess various image attributes.

In various implementations, source images 106 can be captured by imaging sensors on mobile devices, robotics devices, autonomous devices, etc. Source images 106 can be captured and processed locally or externally on a server to obtain images of other views of the scene. Source images 106 can be frames of a video capture. The framework 100 can execute in batch processing or in real-time streaming (e.g., for robotic perception, etc.). Computing systems can perform novel view synthesis as a service (e.g., via an API).

Image view synthesis model 108 can include one or more machine-learned models or model components. Image view synthesis model 108 can include one or more convolutional neural networks or convolutional layers. Image view synthesis model 108 can include one or more attention mechanisms or other components from a transformer block. Image view synthesis model 108 can include a diffusion model architecture.

Image view synthesis model 108 can process source images 106 and, in view of latent pose data, generate a novel view of scene 102. Image view synthesis model 108 can obtain values that encode a latent representation of scene 102. Image view synthesis model 108 can generate the latent scene representation based on source images 106. Image view synthesis model 108 can use latent pose data to effectively query the latent scene representation to generate a novel view responsive to the query.

The latent scene representation can have fixed or variable dimensions. The latent scene representation can be stored as a tensor or other data object. The latent scene representation can be a uniform set of values generated to represent scene 102. The latent scene representation can be a subdivided set of values that represent different aspects of scene 102. For instance, the latent scene representation can identify latent encoding data associated with one or more individual source images of source images 106.

Image view synthesis model 108 can leverage an encoder-decoder architecture. An encoder can process source images 106 to generate the latent scene representation. The encoder can include, for example, a convolutional neural network configured to generate feature maps from source images 106. For example, a convolutional neural network can process each source image independently to generate one or more features maps for each image.

Features in the feature maps (e.g., individual “pixels” of the feature map, such as a spatial 2D coordinate with which one or more channels of data are associated) can be augmented with one or more other data types. For example, position embeddings can be added to each feature or to groups of features (e.g., to the feature map as a whole) to indicate a spatial relationship with the original image (e.g., pointing to a location of the original image that the feature map describes). The position embeddings can be learned or learnable.

An encoder can include additional learned components that generate a latent scene representation from the feature map(s). For example, a sequence processing model can process a sequence of input elements corresponding to the feature map(s). For example, one or more feature maps can be flattened and serialized. The features maps from all source images 106 can be flattened and combined into a set of input elements (e.g., tokens) that can be processed as an input sequence using a sequence processing model (e.g., a transformer-based model).

A sequence processing model or model component of the encoder can attend over the sequence to exchange and propagate information across the features. For example, a transformer-based attention layer can attend over the input sequence and generate updated element values. The attention layer can perform self-attention over the input sequence. The updated element values can pass to another transformer-based attention layer (which can be the same or different as the first) that can attend over the updated element values to generate further updated element(s). In this manner, for instance, a latent scene representation can include elements that encode information about a portion of the scene with respect to other portions of the scene. For example, the latent scene representation can be a set of updated elements output by a transformer block (e.g., a “bag of tokens”).

Image view synthesis model 108 can include a machine-learned decoder model or model component that can process the latent scene representation and generate an output image 112 that corresponds to the scene. For example, the machine-learned decoder model can be configured to generate image data based on the latent scene representation. For example, the machine-learned decoder model can generate pixel data (e.g., color values, brightness values, etc.) for pixels of an image. The machine-learned decoder model can generate image data describing one pixel or a patch of multiple pixels in a single forward pass. For instance, the machine-learned decoder model can include a diffusion model architecture that generates image data conditioned on the latent scene representation as context. The machine-learned decoder model can include a regression model architecture that regresses one or more values for one or more channels of an output image (e.g., for one or more pixels of an output image).

An example machine-learned decoder model can include one or more transformer-based attention layers that can attend over the latent scene representation to extract scene information related to a query. The query can include one or more latent pose parameters (e.g., a query based on latent pose data). The query can include a target position for the output (e.g., a 2D position of a pixel in the output image). An attention layer of the decoder can cross-attend between the query and the latent scene representation. The attention layer can process the latent scene representation and the query to pass information from the latent scene representation into an updated query representation.

The machine-learned decoder model can process a hidden state of the decoder (e.g., one or more intermediate output(s) of one or more internal transformer-based attention layers) using one or more output layers. The output layers can include, for instance, a feedforward network, such as a multilayer perceptron. The feedforward network can output one or more channel values for an output image (e.g., an RGB value for a pixel, such as the pixel corresponding to the target position indicated in the query).

Target view 104 can include any desired perspective or viewpoint from which an image of a scene is to be generated. Target view 104 can be constrained or unconstrained. For instance, target view 104 can be constrained to viewpoints or fields of view within a threshold distance or difference from viewpoints or fields of view represented in source images 106.

Target view 104 can correspond to a novel view of scene 102. For instance, target view 104 can correspond to a view of scene 102 that is different from views represented in source images 106. Target view 104 can correspond to a different incident direction of an incident ray toward scene 102. Target view 104 can correspond to a different viewpoint from which an incident ray originates (e.g., having the same or different ray direction).

To cause image view synthesis model 108 to generate an output image depicting a novel view that corresponds to target view 104, image view synthesis model 108 can process a latent scene representation in view of latent pose data.

Latent pose data can include latent pose values that, when ingested by image view synthesis model along with a latent scene representation, can cause image view synthesis model 108 to generate image data that is associated with a pose parameterized in the latent pose space. Latent pose data can include a tensor of one or more values that correspond to dimensions of a latent pose space.

For example, image view synthesis model 108 can learn an implicit pose space of camera poses using a pose estimator model. A pose estimator model can, during training, estimate a latent pose query associated with a training output image. For instance, one or more portions of a training output image can be processed by the pose estimator model to generate a pose parameterized in the latent pose space (e.g., so that the output image corresponds to the same view as the training output image to facilitate evaluation during training).

The pose estimator model can include a convolutional neural network configured to generate feature maps from the one or more portions of the training output image. For example, a convolutional neural network can process a region (e.g., a quadrant, a half, a patch, etc.) of the training output image to infer an orientation of the view associated with that image. Features in the feature maps (e.g., individual “pixels” of the feature map, such as a spatial 2D coordinate with which one or more channels of data are associated) can be augmented with one or more other data types. For example, position embeddings can be added to each feature or to groups of features (e.g., to the feature map as a whole) to indicate a spatial relationship with the original image (e.g., pointing to a location of the original image that the feature map describes). The position embeddings can be learned or learnable.

The pose estimator model can include additional learned components that generate a latent poser from the feature map(s). For example, a sequence processing model can process a sequence of input elements corresponding to the feature map(s). For example, one or more feature maps can be flattened and serialized. The features maps from the training output image can be flattened and combined into a set of input elements (e.g., tokens) that can be processed as an input sequence using a sequence processing model (e.g., a transformer-based model).

A sequence processing model or model component of the pose estimator model can attend over the sequence to exchange and propagate information across the features. A sequence processing model or model component of the pose estimator model can cross-attend over the sequence and the latent scene representation to determine how the training target image is oriented with respect to the scene. For example, a transformer-based attention layer can attend over the input sequence and generate updated element values. The attention layer can perform self-attention over the input sequence. The updated element values can pass to another transformer-based attention layer (which can be the same or different as the first) that can attend over the updated element values to generate further updated element(s). The hidden state can be projected to a desired output format, such as a tensor containing latent pose data.

Image view synthesis model 108 can generate output image 112 by querying over the latent scene representation using a query that contains latent pose data. Image view synthesis model 108 can generate output image 112 by processing one or multiple queries associated with a given set of latent pose data. For example, a given set of latent pose data can define a target view. Image view synthesis model 108 can process a query for that target view for each position in a desired output image (e.g., each pixel, each patch, etc.) to obtain value(s) of the image at those location(s).

Output image 112 can include any variety of image data that can be the same format as or a different format from source images 106. Output image 112 can include a complete image or a part of an image or a layer to be overlaid another image.

Output image 112 can be further processed after generation. For example, an image processing model can increase a resolution or detail in output images 112. Another machine-learned model can use output images 112 as context. For example, a machine-learned sequence processing model can process output image 112 in combination with natural language inputs to answer questions or otherwise follow instructions regarding scene 102.

Image view synthesis framework 100 can pass output image 112 to other downstream systems. Image view synthesis framework 100 can pass output image 112 to a robotics perception system. Image view synthesis framework 100 can pass output image 112 to an augmented reality or virtual reality system. Image view synthesis framework 100 can pass output image 112 to a display device for displaying output image 112.

With reference to image view synthesis model 108 in more detail, image view synthesis model 108 can include a plurality of attention streams 110-A, 110-B, 110-C. The attention streams can correspond to source images 106 respectively. For instance, a respective attention stream can attend over a query ray (e.g., corresponding to target view 104) and one or more other values (e.g., key or value parameters of a transformer block) using a respective relative pose associated with a respective source image corresponding to the respective attention stream.

For example, a plurality of queries can include a query set Q having i×j members, where i is a number of source images and j is a number of patches or tokens used to represent each source image in the model inputs. A self-attention operation between a query Qᵢⱼ (e.g., a query value associated with a j-th patch of the i-th image) and a key K_{i′j′} (e.g., a key value associated with a j′-th patch of the i′-th image) can use relative poses therebetween. For example, a pose-augmented query can be computed as

$${Q}_{ij} = {x}_{ij} ⊕ γ ( \prod ( {r}_{ij} , {C}_{{i}^{′}} ) )$$

where xᵢⱼ is a j-th latent patch encoding of a source image i (or a feature map F thereof), ⊕ represents vector concatenation, γ represents a sinusoidal positional encoding, and Π(rᵢⱼ, C_{i′}) constructs the origin and direction of a ray r in the local coordinate system of camera C associated with source image i′. The pose-augmented key value can be computed as

$${K}_{{i}^{′} {j}^{′}} = {x}_{{i}^{′} {j}^{′}} ⊕ γ ( \prod ( {r}_{{i}^{′} {j}^{′}} , {C}_{{i}^{′}} ) )$$

such that the source pose between the query Qᵢⱼ and the key value K_{i′j′} can be defined relative to a camera space selected for the particular computation (e.g., the camera space of the key value) instead of a single fixed origin. In this manner, for instance, a plurality of source poses can be computed for each of a plurality of queries.

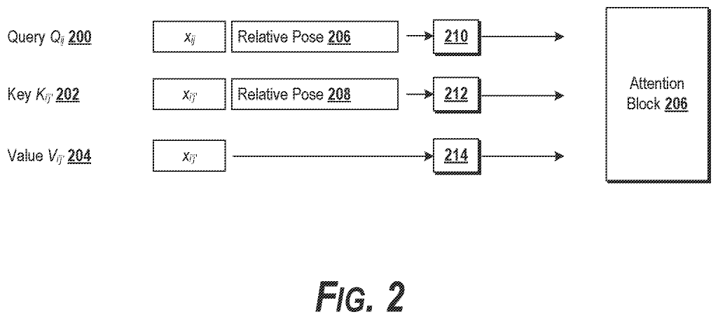

FIG. 2 illustrates an example of the relative pose attention (RePA) architecture block. Computing a query 200, key 202, and value 204 for input to attention block 206 can include augmenting one or more of the components with a relative pose. For example, query 200 can include a relative pose 206. For example, query 200 can include a relative pose 206 combined with latent patch values (e.g., an embedding of a portion of image data) xᵢⱼ. Key 202 can include a relative pose 208. For example, key 202 can include a relative pose 208 combined with latent patch values (e.g., an embedding of a portion of image data) x_{i′j′}. Value 204 is not illustrated as receiving a relative pose, although it is to be understood that such a variation is contemplated.

Output projection layers 210, 212, and 214 can ingest and output query 200, key 202, and value 204 for input to attention block 206.

Attention block 206 can be an attention block configured for attending over values of an input sequence. Attention block 206 can include a multi-head or multi-query attention block. An example attention operation between a query Q, key K, and value V can be represented as

$$Attention ( Q , K , V ) = softmax ( \frac{{QK}^{T}}{\sqrt{{d}_{k}}} V )$$

where dₖ is used to scale the output. See, e.g., Vaswani et al., Attention Is All You Need, ARXIV:1706.03762v7 (Aug. 2, 2023).

In an example approach, executing a RePA block proceeds as follows:
1. Group key-value pairs in sets (K₁; V₁), . . . (K_{N}; V_{N}) associated with N input cameras.
2. Add auxiliary pose information to the query and the key-value pairs sets.
3. Compute attention values for every set of query, key, and value. The softmax operation of the attention computation can be performed globally for all N streams.

FIG. 2 illustrates an example self-attention operation over values within x. It is to be understood that the architecture of FIG. 2 can also be used for cross-attention to cross-attend between a query value and one or more other values. For instance, example implementations of image view synthesis model 108 can include one or both implementations.

FIG. 2 illustrates an example relative pose attention block. While generally example implementations described herein focus on the context of image processing, specifically image view synthesis, it is to be understood that relative pose attention using an example relative pose attention block can be implemented in a variety of different contexts, such as text processing, symbolic processing, audio processing, video processing, LIDAR processing, RADAR processing, time series forecasting, etc.

For instance, an encoder can self-attend over embedded values x of images of a scene. The output of one or more layers of such an encoder can be a set-latent scene representation (SLSR) that encodes rich information about the scene. The SLSR can include a set of latent patch tokens that can remain associated with different patches of different input images (e.g., by processing as a sequence with known ordering). Attention streams in the encoder can correspond to each respective source image or each respective latent patch token.

To decode novel views, a decoder can cross-attend between a novel query viewpoint and the SLSR generated by the encoder. In an example, attention streams in the decoder can correspond to each respective source image or each respective latent patch token.

In some implementations, the encoder can use the augmented pose information in the attention computations while the decoder can omit augmenting the pose information. For example, the query pose in the decoder may already be known, since it can be drawn from the desired query ray. In some implementations, the encoder can use the augmented pose information in the attention computations and the decoder can also augment the pose information. In some cases this can provide helpful context in the attention computation and lead to improved output.

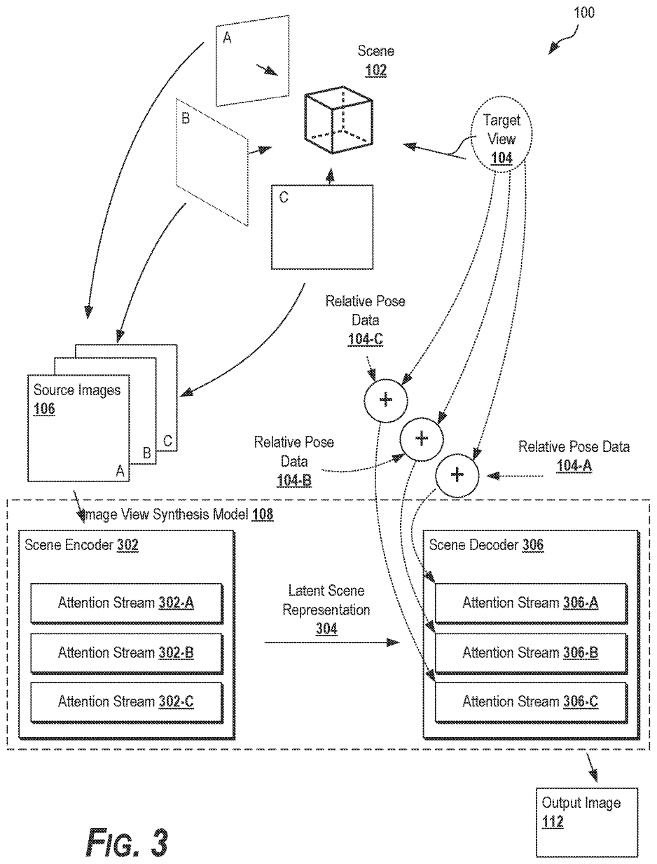

FIG. 3 illustrates an example encoder-decoder architecture for image view synthesis model 108. Image view synthesis model 108 can include a scene encoder 302 configured to process source images 106 to generate a latent scene representation 304 for input to a scene decoder 306. The scene encoder 302 can include multiple attention streams 302-A, 302-B, 302-C. The scene decoder 306 can include multiple attention streams 306-A, 306-B, 306-C. The encoder attention streams can be the same as or different from the decoder attention streams. These attention streams can correspond to different source poses of source images 106 (or patches thereof). For instance, in the encoder, each attention stream can be configured for learning about the stream from the viewpoint of a respective source image (or patch thereof). In the decoder, each attention stream can be configured for determining what information from the latent scene representation 304 is pertinent to servicing the query.

A pose-augmented query can be processed using a respective attention stream of the decoder. For instance, a query based on a target view 104 can be combined with relative pose data corresponding to a respective attention stream. This approach can be used to generate a plurality of pose-augmented queries (e.g., using relative pose data 104-A, 104-B, 104-C for input to attention streams 306-A, 306-B, 306-C, etc.). Relative pose data can include data describing a pose of a camera associated with target view 104 as relative to cameras of source images A, B, and C.

Encoder 302 can perform self-attention over source images 106. Decoder 306 can cross-attend between pose-augmented queries associated with target view 104 and latent scene representation 304.

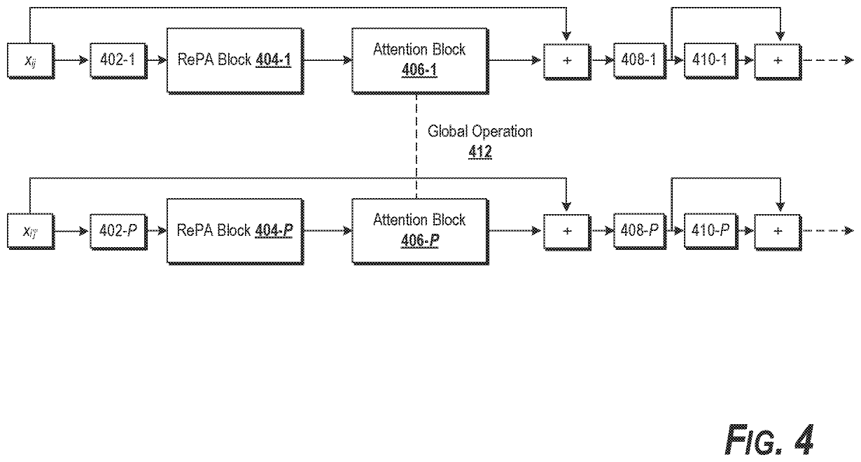

FIG. 4 is a diagram of an example encoder 302 having P attention streams. P can be equal to a number of source images N. Within each of the N streams, the RePA block from FIG. 2 can be implemented j times (e.g., with one or more batched groups of size j), depending on the patch quantity. P can be equal to a number of individual patches or latent tokens (e.g., i×j).

In one stream, a latent patch embedding xᵢⱼ can be processed by a first layer 402-1 (e.g., a linear layer). The output of layer 402-1 can be processed by RePA block 404-1. The output of RePA block 404-1 can be processed by attention block 406-1. Attention block 406-1 can be an attention block applied in addition to an attention block internal to RePA block 404-1. Attention block 406-1 can represent the attention block internal to RePA block 404-1 (e.g., RePA block 404-1 as drawn may not include an attention block as drawn in FIG. 2). The output of attention block 406-1 can be combined with a skip connection that adds in the latent patch embedding (e.g., without the augmented pose value). This combined value can pass to another layer 408-1 (e.g., a linear layer), the output of which can pass to a nonlinear layer 410-1 (e.g., a fully connected layer, a multilayer perceptron, etc.). A skip connection can be combined with the output of nonlinear layer 410-1, with the source of the skip connection being the input or the output of the linear layer (output as source being drawn in FIG. 4).

In the P-th stream, a latent patch embedding x_{i′j′} can be processed by a first layer 402-P (e.g., a linear layer). The output of layer 402-P can be processed by RePA block 404-P. The output of RePA block 404-P can be processed by attention block 406-P. Attention block 406-P can be an attention block applied in addition to an attention block internal to RePA block 404-P. Attention block 406-P can represent the attention block internal to RePA block 404-P (e.g., RePA block 404-P as drawn may not include an attention block as drawn in FIG. 2). The output of attention block 406-P can be combined with a skip connection that adds in the latent patch embedding (e.g., without the augmented pose value). This combined value can pass to another layer 408-P (e.g., a linear layer), the output of which can pass to a nonlinear layer 410-P (e.g., a fully connected layer, a multilayer perceptron, etc.). A skip connection can be combined with the output of nonlinear layer 410-P, with the source of the skip connection being the input or the output of the linear layer (output as source being drawn in FIG. 4).

A global operation 412 can be applied over all the attention blocks of the P streams. The global operation can facilitate information sharing across streams. The output of the respective attention blocks—although drawn with separate boxes and arrows in FIG. 4—can be a common output from the global operation. Further, although drawn in separate blocks, it is to be understood that attention blocks 406-1, . . . , 406-N can be implemented as batches within a global attention block. Global operation 412 can be a global softmax (e.g., the softmax of the attention computation being applied over the queries, keys, and values of all streams).

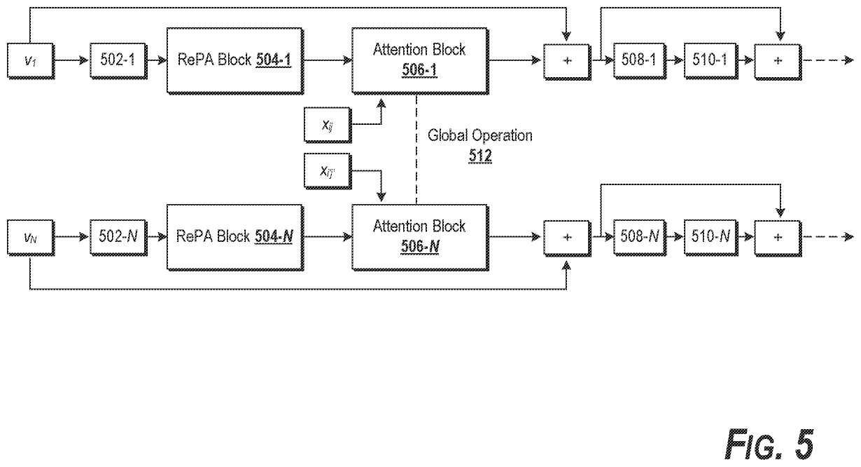

FIG. 5 is a diagram of an example encoder 306 having N attention streams corresponding to a number of source images N. Within each of the N streams, the RePA block from FIG. 2 can be implemented j times (e.g., with one or more batched groups of size j), depending on the patch quantity.

To query latent scene representation 304, a query embedding can be initialized for each image. Each query embedding can be sequentially updated by one or more decoder blocks to obtain predictions for an output value based on each stream. A final output layer can mix the individual predictions to obtain a single output value (e.g., a RGB vector for a point in space, such as for a pixel in an image).

In one stream, a latent query embedding v₁ can be processed by a first layer 502-1 (e.g., a linear layer). The output of layer 502-1 can be processed by RePA block 504-1. The output of RePA block 504-1 can be processed by attention block 506-1. Attention block 506-1 can be an attention block applied in addition to an attention block internal to RePA block 504-1. Attention block 506-1 can represent the attention block internal to RePA block 504-1 (e.g., RePA block 504-1 as drawn may not include an attention block as drawn in FIG. 2).

Attention block 506-1 can cross-attend between latent query embedding vᵢ and a set of latent patch embeddings x_{i, 1}, . . . , x_{i,j} associated with the corresponding i-th source image (e.g., Q based on the latent query embedding v₁ and K and V based on the latent patch embeddings). For example, attention block 506-1 can execute with one or more batched groups of size j.

The output of attention block 506-1 can be combined with a skip connection that adds in the latent patch embedding (e.g., without the augmented pose value). This combined value can pass to another layer 508-1 (e.g., a linear layer), the output of which can pass to a nonlinear layer 510-1 (e.g., a fully connected layer, a multilayer perceptron, etc.). A skip connection can be combined with the output of nonlinear layer 510-1, with the source of the skip connection being the input or the output of the linear layer (input as source being drawn in FIG. 5).

In the N-th stream, a latent query embedding v_{N} can be processed by a first layer 502-N (e.g., a linear layer). The output of layer 502-N can be processed by RePA block 504-N. The output of RePA block 504-N can be processed by attention block 506-N. Attention block 506-N can be an attention block applied in addition to an attention block internal to RePA block 504-N. Attention block 506-N can represent the attention block internal to RePA block 504-N (e.g., RePA block 504-N as drawn may not include an attention block as drawn in FIG. 2). The output of attention block 506-N can be combined with a skip connection that adds in the latent patch embedding (e.g., without the augmented pose value). This combined value can pass to another layer 508-N (e.g., a linear layer), the output of which can pass to a nonlinear layer 510-N (e.g., a fully connected layer, a multilayer perceptron, etc.). A skip connection can be combined with the output of nonlinear layer 510-N, with the source of the skip connection being the input or the output of the linear layer (output as source being drawn in FIG. 5).

A global operation 512 can be applied over all the attention blocks of the N streams. The global operation can facilitate information sharing across streams. The output of the respective attention blocks—although drawn with separate arrows in FIG. 5—can be a common output from the global operation. Further, although drawn in separate blocks, it is to be understood that attention blocks 506-1, . . . , 506-N can be implemented as batches within a global attention block. Global operation 512 can be a global softmax (e.g., the softmax of the attention computation being applied over the queries, keys, and values of all streams).

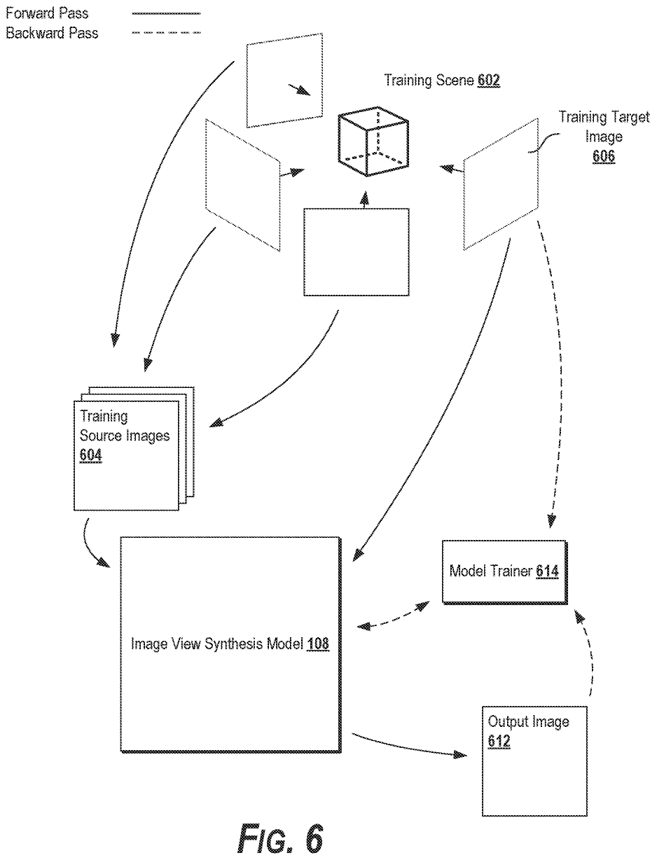

FIG. 6 is a block diagram of an example process flow for training an example image view synthesis framework according to example aspects of some embodiments of the present disclosure. A forward pass can use a set of training data associated with a training scene 602. Training data can include training source images 604 and training target image(s) 606 which depict the training scene 602 from different views. Based on the training source images 606 and a pose associated with the training target image 606, image view synthesis model 108 can generate output image 612.

In a backward pass, a model trainer 614 can evaluate output image 612 against training target image 606 (e.g., with a reconstruction loss, or other loss or score). The model trainer 614 can update one or more parameters of image view synthesis model 108 based on the evaluation to improve the quality of output image 612.

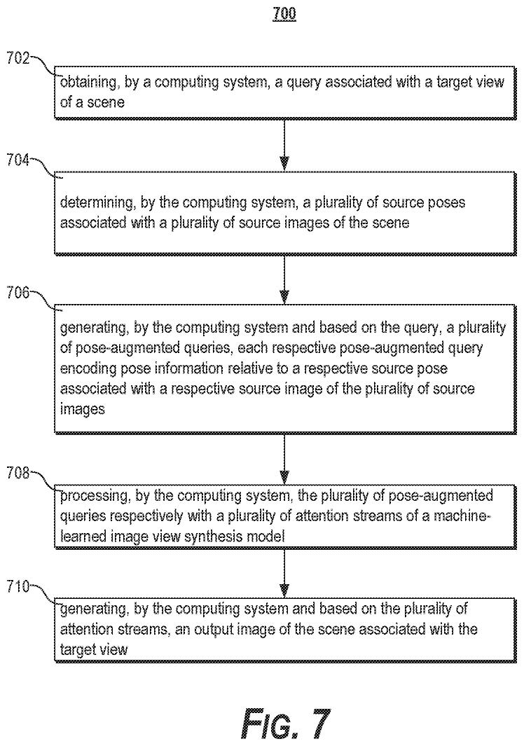

FIG. 7 depicts a flowchart of a method 700 for performing image view synthesis according to example aspects of the present disclosure. One or more portion(s) of example method 700 can be implemented by a computing system that includes one or more computing devices such as, for example, computing systems described with reference to the other figures. Each respective portion of example method 700 can be performed by any (or any combination) of one or more computing devices. Moreover, one or more portion(s) of example method 700 can be implemented on the hardware components of the device(s) described herein. One or more non-transitory computer-readable media can store instructions that are executable to perform one or more operations, the operations including one or more parts or aspects of example method 700.

FIG. 7 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 7 is described with reference to elements/terms described with respect to other systems and figures for exemplary illustrated purposes and is not meant to be limiting. One or more portions of example method 700 can be performed additionally, or alternatively, by other systems.

At 702, example method 700 can include obtaining, by a computing system, a query associated with a target view of a scene. For example, the query can be a target query 104. The query can be a training query input to an encoder drawn from a set of input image data (e.g., a latent patch embedding used as query 200).

At 704, example method 700 can include determining, by the computing system, a plurality of source poses associated with a plurality of source images of the scene. For example, the plurality of source poses can be determined using one or more camera pose parameters associated with a real or simulated image capture. Camera pose parameters can include, for instance, one or more parameters of a camera matrix or projection matrix.

At 706, example method 700 can include generating, by the computing system and based on the query, a plurality of pose-augmented queries, each respective pose-augmented query encoding pose information relative to a respective source pose associated with a respective source image of the plurality of source images.

At 708, example method 700 can include processing, by the computing system, the plurality of pose-augmented queries respectively with a plurality of attention streams of a machine-learned image view synthesis model.

At 708, example method 700 can include generating, by the computing system and based on the plurality of attention streams, an output image of the scene associated with the target view. For example, the computing system can aggregate over the streams to obtain an aggregate output that provides image data (e.g., color data, reflectance data, etc.) for a point in space or pixel in an image.

In some implementations of example method 700, a respective pose-augmented query includes query pose data transformed relative a respective source pose associated with a corresponding respective attention stream (e.g., a camera matrix associated with an image, a ray associated with a patch, or both, etc.).

In some implementations, example method 700 includes inputting, by the computing system and to a decoder portion of the machine-learned image view synthesis model, a set of latent scene representation parameters, wherein the set of latent scene representation parameters were generated by processing the plurality of source images using an encoder portion of the machine-learned image view synthesis model. For example, the set of latent scene representation parameters can be latent scene parameters 304.

In some implementations of example method 700, each respective attention stream is configured to process image feature data associated with a respective source pose of the plurality of source poses. For example, an attention stream 110-A or attention stream 302-A or attention stream 306-A can be associated with a camera pose corresponding to a source image. For instance, query, key, or value parameters can be augmented with relative poses that are defined relative to the camera pose. The selected camera pose for a given computation across a query, a key, and a value can be the camera pose associated with the key.

In some implementations of example method 700, a respective attention stream of the encoder portion is configured to process image patch data associated with a respective source pose of the plurality of source poses. For example, the image patch data can be processed to form a key value for an attention computation, such that the pose values used for the respective attention stream are computed with respect to the camera pose corresponding to the key values.

In some implementations of example method 700, a respective attention stream of the decoder portion is configured to process a subset of latent scene representation parameters associated with a respective source pose of the plurality of source poses. For example, a respective attention stream can be associated with a respective source pose such that augmented pose values (e.g., for a pose-augmented query, pose-augmented key, etc.) are defined with respect to a camera space of the respective source pose (e.g., for a corresponding source image used to generate the latent scene representation parameters).

In some implementations of example method 700, outputs of the encoder portion are grouped according to the corresponding source poses of the inputs to the encoder portion.

In some implementations of example method 700, the decoder portion of the machine-learned image view synthesis model is configured to cross-attend between the plurality of pose-augmented queries and a set of latent scene representation parameters, wherein the set of latent scene representation parameters were generated by processing the plurality of source images using an encoder portion of the machine-learned image view synthesis model.

In some implementations of example method 700, the machine-learned image view synthesis model is configured to combine respective outputs of the plurality of attention steams. For instance, an output of an attention stream can be a prediction of a value (e.g., color, reflectance, etc.) at a desired output point (e.g., point in space, pixel value, etc.). The respective outputs can be combined using a weighted combination, processing with a learned linear layer, a learned nonlinear layer, a multilayer perceptron, etc. to generate a final output value.

In some implementations of example method 700, the machine-learned image view synthesis model is configured to mix respective outputs of the plurality of attention streams using a softmax computed globally across the plurality of attention streams. For instance, an attention block can implement a softmax operator over a given combination of queries, keys, and values for a respective stream. Queries, keys, and values for a different stream can also be concatenated to the queries, keys, and values for the respective stream such that the softmax operator operates globally over both streams. A global output of the softmax layer can be returned to each stream for further processing.

In some implementations of example method 700, the decoder portion of the machine-learned image view synthesis model includes a plurality of attention streams that each comprise a respective set of keys and a respective set of values, the respective set of keys being augmented with pose information relative to the respective source pose.

In some implementations of example method 700, the pose-augmented query includes a base query concatenated with target pose information relative to the respective source pose, and wherein the augmented keys comprise a base key value concatenated with pose information relative to the respective source pose information. For instance, the target pose information can be a pose associated with a query ray (e.g., for a latent patch token operating as a query in an encoder, a target view token operating as a query in a decoder, etc.) defined with respect to a camera pose of the source image. The pose information relative to the respective source pose information for the key can be, for instance, a pose of a source ray associated with a given patch of a source image defined with respect to a camera pose of the source image.

In some implementations of example method 700, the query updates the combined output of the plurality of attention streams with a skip connection. For instance, a skip connection can add the pre-augmented content of a query (or key, or value) to an output of an attention block that executes over the pose-augmented query (or key, or value).

In some implementations, example method 700 includes obtaining, by the computing system, training source images of a training scene, wherein the training source images are associated with a training target image associated with a training target view of the training scene. In some implementations, example method 700 includes generating, by the computing system and using the machine-learned image view synthesis model, a training output image associated with the training target view. In some implementations, example method 700 includes training, by the computing system and based on a comparison of the training output image and the training target image, the machine-learned image view synthesis model.

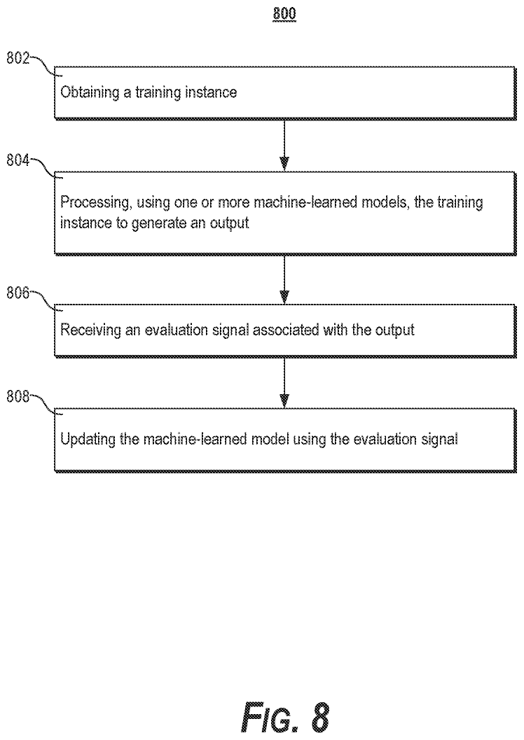

FIG. 8 depicts a flowchart of a method 800 for training a machine-learned model according to example aspects of the present disclosure. One or more portion(s) of example method 800 can be implemented by a computing system that includes one or more computing devices such as, for example, computing systems described with reference to the other figures. Each respective portion of example method 800 can be performed by any (or any combination) of one or more computing devices. Moreover, one or more portion(s) of example method 800 can be implemented on the hardware components of the device(s) described herein. One or more non-transitory computer-readable media can store instructions that are executable to perform one or more operations, the operations including one or more parts or aspects of example method 800.

FIG. 8 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 8 is described with reference to elements/terms described with respect to other systems and figures for exemplary illustrated purposes and is not meant to be limiting. One or more portions of example method 800 can be performed additionally, or alternatively, by other systems.

At 802, example method 800 can include obtaining a training instance. A set of training data can include a plurality of training instances divided between multiple datasets (e.g., a training dataset, a validation dataset, or testing dataset). A training instance can be labeled or unlabeled. Although referred to in example method 800 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 804, example method 800 can include processing, using one or more machine-learned models, the training instance to generate an output. The output can be directly obtained from the one or more machine-learned models or can be a downstream result of a chain of processing operations that includes an output of the one or more machine-learned models.

At 806, example method 800 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 808, example method 800 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 800 can include implementing a number of generalization techniques (e.g., weight decays, dropouts, etc.) to improve the generalization capability of the models being trained.

In some implementations, example method 800 can be implemented for training a machine-learned model from an initialized state to a fully trained state (e.g., when the model exhibits a desired performance profile, such as based on accuracy, precision, recall, etc.).

In some implementations, example method 800 can be implemented for particular stages of a training procedure. For instance, in some implementations, example method 800 can be implemented for pre-training a machine-learned model. Pre-training can include, for instance, large-scale training over potentially noisy data to achieve a broad base of performance levels across a variety of tasks/data types. In some implementations, example method 800 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

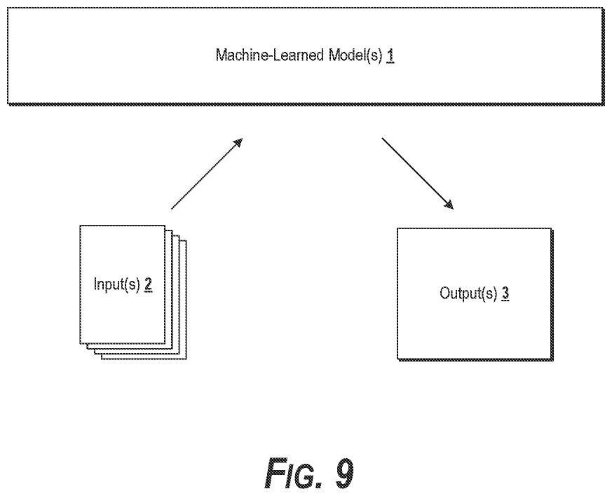

FIG. 9 is a block diagram of an example processing flow for using machine-learned model(s) 1 to process input(s) 2 to generate output(s) 3.

Machine-learned model(s) 1 can be or include any one of or any part of machine-learned models referenced with respect to the preceding figures (e.g., models 108, 302, 306, etc.). For example, any one or multiple of machine-learned models 108, 302, 306, etc. can be a machine-learned model 1. Features and variations described herein with respect to machine-learned model 1 are to be understood as describing features and variations of any of the machine-learned models described herein. Where this description references machine-learned model 1 it is to be understood that implementations of each of the other models described herein are implicitly referenced and represented thereby.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, ARXIV:2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

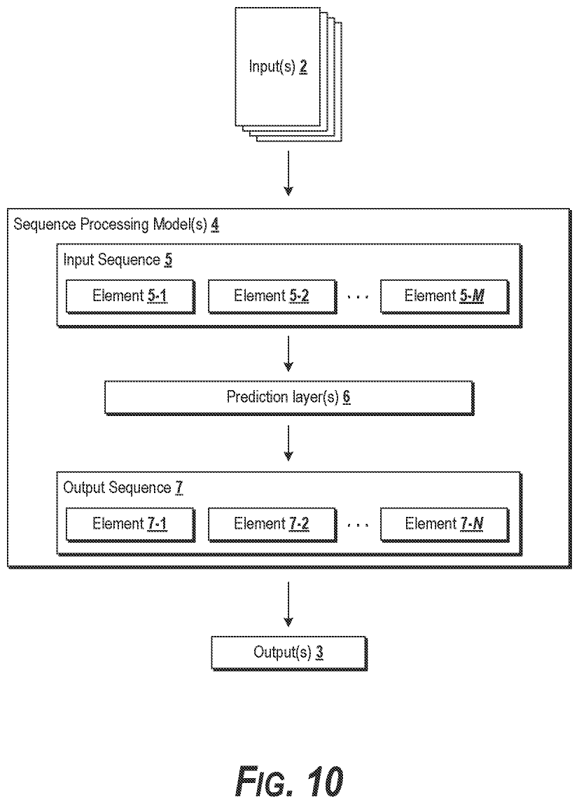

FIG. 10 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV:2010.11929v2 (Jun. 3, 2021), audio domains, see, e.g., Agostinelli et al., MusicLM: Generating Music From Text, ARXIV:2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct. 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 10 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, ARXIV:1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multilayer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

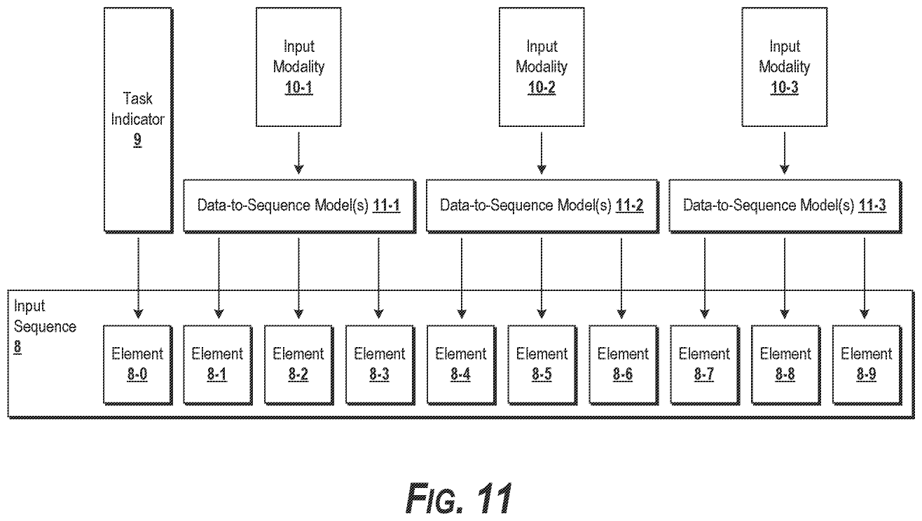

FIG. 11 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

An example data-to-sequence model can include an encoder 302 configured to generate a tokenized latent representation of a scene for understanding by a downstream model.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be a learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

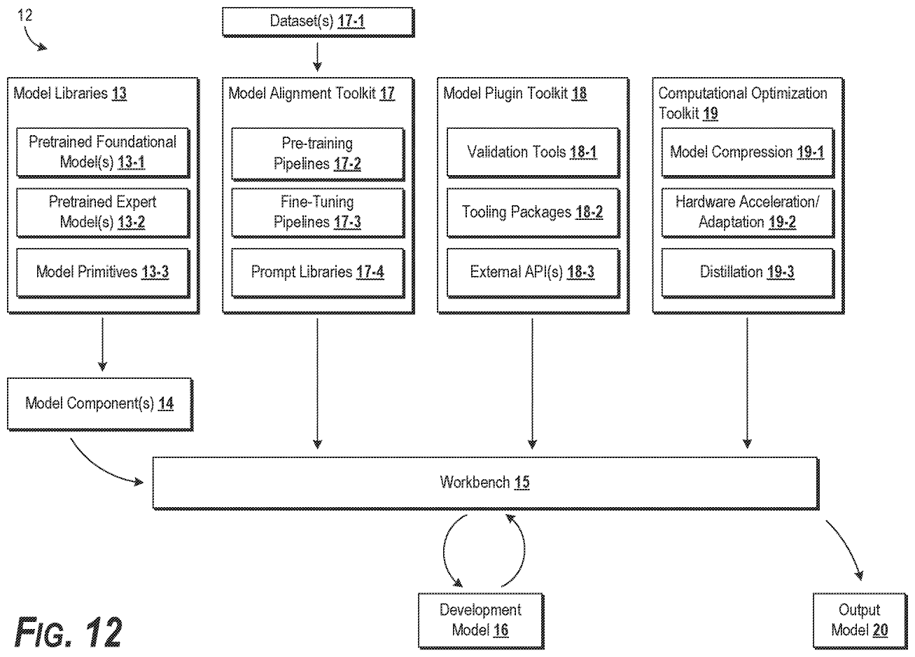

FIG. 12 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output a input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 800 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task-while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instruction that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

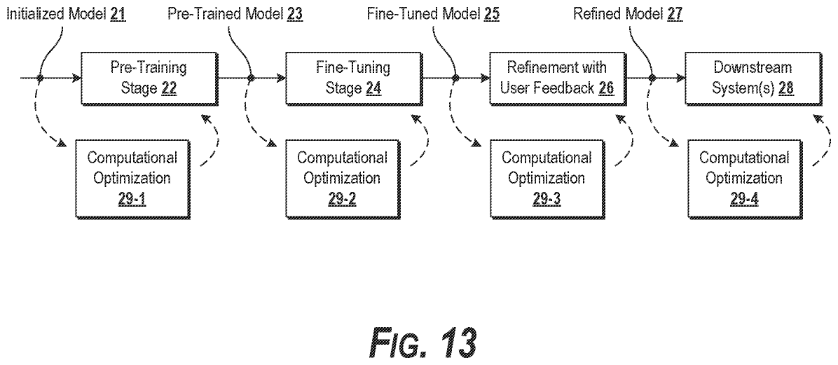

FIG. 13 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 13 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 13 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model as satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

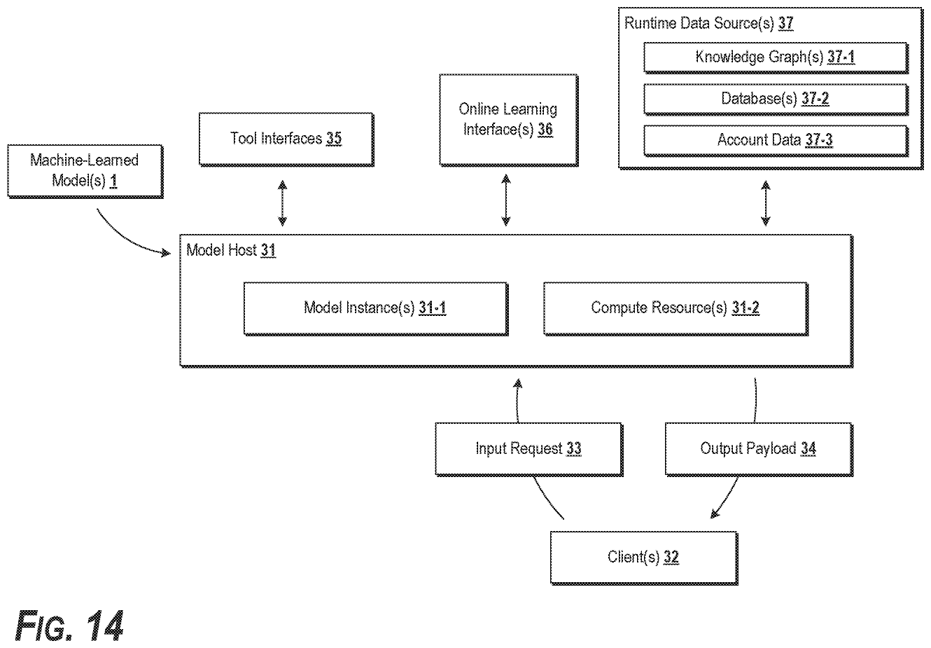

FIG. 14 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored on in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

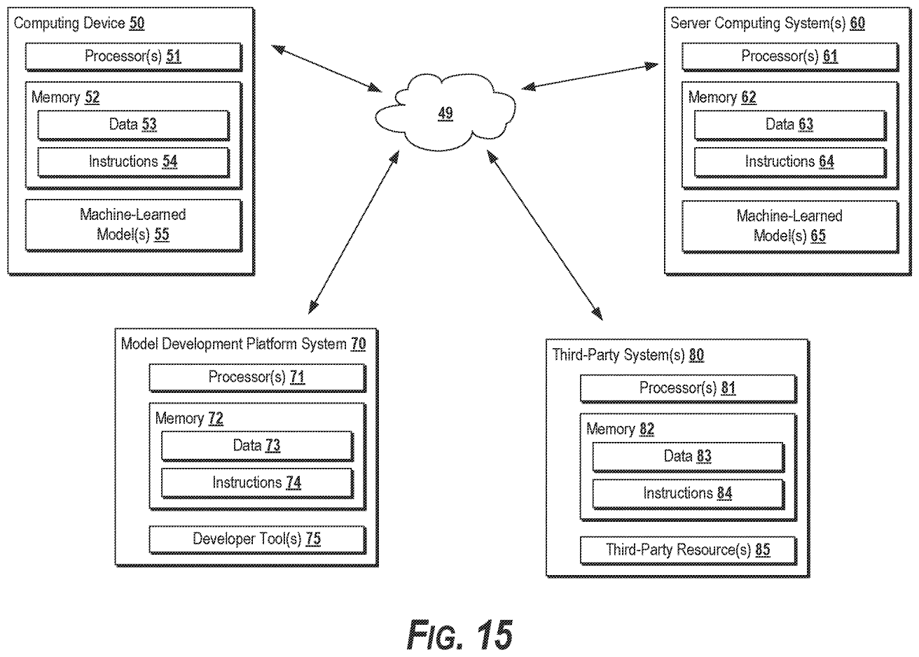

FIG. 15 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 15 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 15 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

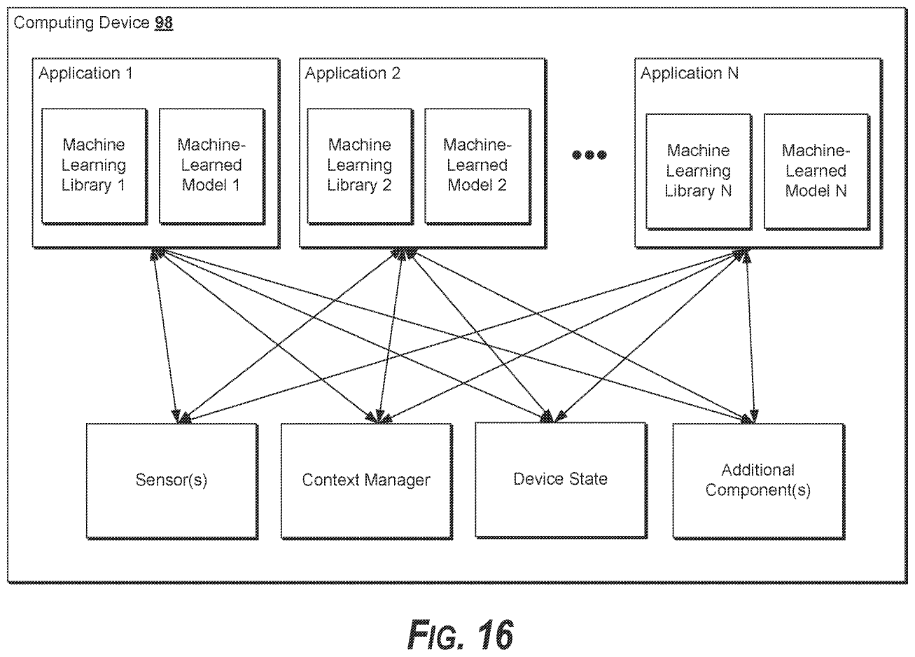

FIG. 16 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 16, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

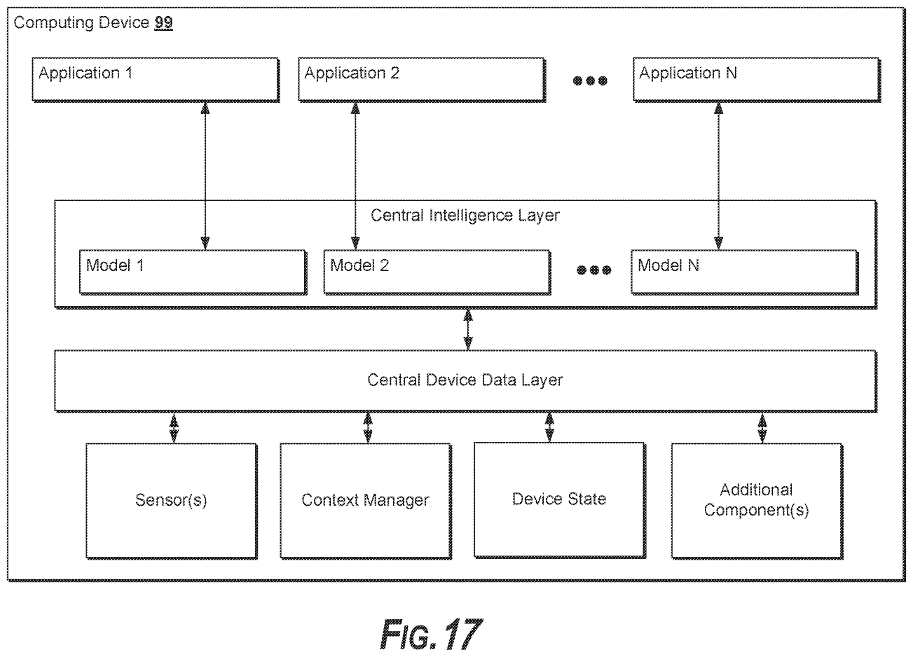

FIG. 17 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 17, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 17, the central device data layer can communicate with a number of other components of the computing device, such as, for example, one or more sensors, a context manager, a device state component, or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

1. A computer-implemented method for image view synthesis, the method comprising:
obtaining, by a computing system, a query associated with a target view of a scene;
determining, by the computing system, a plurality of source poses associated with a plurality of source images of the scene;
generating, by the computing system and based on the query, a plurality of pose-augmented queries, each respective pose-augmented query encoding pose information relative to a respective source pose associated with a respective source image of the plurality of source images;
processing, by the computing system, the plurality of pose-augmented queries respectively with a plurality of attention streams of a machine-learned image view synthesis model; and
generating, by the computing system and based on the plurality of attention streams, an output image of the scene associated with the target view.

2. The computer-implemented method of claim 1, wherein a respective pose-augmented query comprises query pose data transformed relative a respective source pose associated with a corresponding respective attention stream.

3. The computer-implemented method of claim 1, comprising:
inputting, by the computing system and to a decoder portion of the machine-learned image view synthesis model, a set of latent scene representation parameters, wherein the set of latent scene representation parameters were generated by processing the plurality of source images using an encoder portion of the machine-learned image view synthesis model.

4. The computer-implemented method of claim 1, wherein each respective attention stream is configured to process image feature data associated with a respective source pose of the plurality of source poses.

5. The computer-implemented method of claim 3, wherein:
a respective attention stream of the encoder portion is configured to process image patch data associated with a respective source pose of the plurality of source poses; and
a respective attention stream of the decoder portion is configured to process a subset of latent scene representation parameters associated with a respective source pose of the plurality of source poses.

6. The computer-implemented method of claim 3, wherein outputs of the encoder portion are grouped according to the corresponding source poses of the inputs to the encoder portion.

7. The computer-implemented method of claim 3, wherein the decoder portion of the machine-learned image view synthesis model is configured to cross-attend between the plurality of pose-augmented queries and a set of latent scene representation parameters, wherein the set of latent scene representation parameters were generated by processing the plurality of source images using an encoder portion of the machine-learned image view synthesis model.

8. The computer-implemented method of claim 1, wherein the machine-learned image view synthesis model is configured to combine respective outputs of the plurality of attention streams.

9. The computer-implemented method of claim 1, wherein the machine-learned image view synthesis model is configured to mix respective outputs of the plurality of attention streams using a softmax computed globally across the plurality of attention streams.

10. The computer-implemented method of claim 3, wherein:
the decoder portion of the machine-learned image view synthesis model comprises a plurality of attention streams that each comprise a respective set of keys and a respective set of values, the respective set of keys being augmented with pose information relative to the respective source pose.

11. The computer-implemented method of claim 10, wherein the pose-augmented query comprises a base query concatenated with target pose information relative to the respective source pose, and wherein the augmented keys comprise a base key value concatenated with pose information relative to the respective source pose.

12. The computer-implemented method of claim 8, wherein the query updates the combined output of the plurality of attention streams with a skip connection.

13. The computer-implemented method of claim 1, comprising:
obtaining, by the computing system, training source images of a training scene, wherein the training source images are associated with a training target image associated with a training target view of the training scene;
generating, by the computing system and using the machine-learned image view synthesis model, a training output image associated with the training target view; and
training, by the computing system and based on a comparison of the training output image and the training target image, the machine-learned image view synthesis model.

14. One or more non-transitory computer-readable media storing instructions that are executable by one or more processors to cause a computing system to perform operations, the operations comprising:
obtaining a query associated with a target view of a scene;
determining a plurality of source poses associated with a plurality of source images of the scene;
generating, based on the query, a plurality of pose-augmented queries, each respective pose-augmented query encoding pose information relative to a respective source pose associated with a respective source image of the plurality of source images;
processing the plurality of pose-augmented queries respectively with a plurality of attention streams of a machine-learned image view synthesis model; and
generating, based on the plurality of attention streams, an output image of the scene associated with the target view.

15. A computing system comprising:
one or more non-transitory computer-readable media storing instructions that are executable by one or more processors of the computing system to cause the computing system to perform operations, the operations comprising:
obtaining a query associated with a target view of a scene;
determining a plurality of source poses associated with a plurality of source images of the scene;
generating, based on the query, a plurality of pose-augmented queries, each respective pose-augmented query encoding pose information relative to a respective source pose associated with a respective source image of the plurality of source images;
processing the plurality of pose-augmented queries respectively with a plurality of attention streams of a machine-learned image view synthesis model; and
generating, based on the plurality of attention streams, an output image of the scene associated with the target view.

16. The computing system of claim 15, wherein the computing system comprises a robotic platform with a camera sensor, wherein the robotic platform is configured to navigate an environment based on a latent scene encoding generated using an encoder portion of the machine-learned image view synthesis model.

17. The computing system of claim 15, wherein the computing system comprises a mobile device with a camera sensor.

18. The computing system of claim 17, wherein the mobile device is configured to render augmented reality content on a display device, wherein the augmented reality content is rendered using a novel view generated using the machine-learned image view synthesis model.

19. The computing system of claim 15, wherein the machine-learned image view synthesis model is configured to combine respective outputs of the plurality of attention streams.

20. The computing system of claim 15, the operations comprising:
inputting, to a decoder portion of the machine-learned image view synthesis model, a set of latent scene representation parameters, wherein the set of latent scene representation parameters were generated by processing the plurality of source images using an encoder portion of the machine-learned image view synthesis model.
